(19) United States
(12) Patent Application Publication
(10) Pub. No.: US 2023/0220848 A1
(43) Pub. Date: Jul. 13, 2023

(54) VACUUM PUMP AND VACUUM PUMP CLEANING SYSTEM

(71) Applicant: Edwards Japan Limited, Chiba (JP)

(72) Inventor: Koichi Ichihara, Chiba (JP)

(21) Appl. No.: 18/001,632

(22) PCT Filed: Jul. 7, 2021
(86) PCT No.: PCT/JP2021/025639

§ 371 Date: Dec. 13, 2022

(30) Foreign Application Priority Data
Jul. 14, 2020 (JP) 2020-120673

(51) Int. Cl. F04D 19/04; F04D 15/00; F04D 29/70

(52) U.S. Cl. CPC F04D 19/042; F04D 15/0005; F04D 29/701; F05D 2260/607

(57) ABSTRACT

A vacuum pump is provided that can decompose by-products into particles using radicals and effectively discharge the particles to outside. The vacuum pump includes: an outer cylinder having an inlet port and an outlet port; a rotor shaft rotationally supported inside the outer cylinder; a rotating body including a plurality of rotor blades fixed to the rotor shaft and is rotatable together with the rotor shaft, the vacuum pump further including at least one radical supply port capable of supplying a plurality of types of radicals into the outer cylinder; and a radical supply means for supplying radicals to the radical supply port.

### CROSS-REFERENCE OF RELATED APPLICATION

This application is a Section 371 National Stage Application of International Application No. PCT/JP2021/025639, filed Jul. 7, 2021, which is incorporated by reference in its entirety and published as WO 2022/014442A1 on Jan. 20, 2022 and which claims priority of Japanese Application No. 2020-120673, filed Jul. 14, 2020.

### BACKGROUND

The present invention relates to a vacuum pump and a vacuum pump cleaning system, and more particularly to a vacuum pump and a vacuum pump cleaning system that can remove deposits and the like produced by gas solidification in the vacuum pump.

In recent years, in a process of forming a semiconductor device from a wafer, which is a substrate to be processed, a technique has been adopted that processes the wafer in a processing chamber of a semiconductor manufacturing apparatus, in which a high vacuum is maintained, to produce a semiconductor device as a product. For a semiconductor manufacturing apparatus that processes wafers in a vacuum chamber, a vacuum pump is used that includes a turbomolecular pump portion, a thread groove pump portion, and the like to achieve and maintain a high degree of vacuum (see Japanese Patent Application Publication No. 2019-82120, for example).

The turbomolecular pump portion has, in a housing thereof, thin rotor blades, which are rotatable and made of metal, and stator blades fixed to the housing. The rotor blades are operated at a high speed of several hundred meters per second, for example, and process gas, which was used for processing and enters from the inlet port, is compressed in the pump and exhausted from the outlet port.

Here, molecules of process gas taken in from the inlet port of the vacuum pump may solidify in the compression process accompanying movement of the process gas toward the outlet port caused by rotation of the rotor blades in the vacuum pump. The solidified by-products may adhere and accumulate on the stator blades, the inner surface of the outer cylinder, and the like. The deposits as by-products of the process gas adhering to the stator blades, the inner surface of the outer cylinder, and the like obstruct a course of the gas molecules toward the outlet port. This may result in problems such as a decrease in exhaustion performance of the turbomolecular pump, an abnormality in the processing pressure, and a decrease in production efficiency due to interruptions of processes caused by deposits.

Additionally, particles of the process gas bouncing back from the vacuum pump may flow back into the processing chamber of the semiconductor manufacturing apparatus, thereby contaminating wafers.

As a countermeasure, a vacuum pump has been proposed that includes a radical supply device at the inlet port of the vacuum pump to generate radicals for peeling off and decomposing the deposits that adhere to and accumulate on the stator blades, the inner surface of the outer cylinder, and the like (see Japanese Patent Application Publication No. 2008-248825, for example).

The technique described in Japanese Patent Application Publication No. 2008-248825 places a radical supply portion near the inlet port of a vacuum pump to supply a jet of radicals issuing from a nozzle of the radical supply portion toward the inner center.

The discussion above is merely provided for general background information and is not intended to be used as an aid in determining the scope of the claimed subject matter. The claimed subject matter is not limited to implementations that solve any or all disadvantages noted in the background.

### SUMMARY

The invention of Japanese Patent Application Publication No. 2008-248825 uses a configuration that supplies a jet of radicals from the radical supply portion toward the inner center. The jet is issued from a nozzle at a position that is near the inlet port at a side proximal to a chamber of a semiconductor manufacturing apparatus or the like and at an upper side of the uppermost rotor blade and stator blade. The radicals supplied from the radical supply portion flow together with the process gas in the outer cylinder toward the outlet port. In this process, the radicals decompose the deposits, which adhere to the stator blades, the inner surface of the outer cylinder, and the like, into particles, and are discharged from the outlet port together with the process gas.

The structure that supplies radicals from a position that is near the inlet port proximal to the chamber and at the upper side of the uppermost rotor blade and stator blade as described above has a problem where by-products may be decomposed into particles by reaction with radicals at the inlet port, i.e., the intake side of the vacuum pump, flow back into the chamber, and cause wafer defects.

Also, since radicals are unstable substances that apply a large amount of energy to material gas and forcibly separate molecular bonds, recombination thereof occurs in a relatively short time and activity thereof is lost. As such, the radicals supplied through the inlet port of the vacuum pump may collide with each other or with the stator blades or the housing, for example, whereby the radicals may recombine and lose activity thereof before reaching near the outlet port of the vacuum pump. This results in a problem where the radicals do not spread within the vacuum pump, failing to achieve effective cleaning.

Also, when cleaning is performed by supplying radicals, an excessive supply of radicals causes a problem where the radicals not only decompose by-products but also deteriorate the process chamber or components constituting the vacuum pump.

Furthermore, in recent years, by-products have emerged that cannot be decomposed into particles by reaction with a single type of radicals, such as TiN (tin).

In view of the foregoing, it is an object of the present invention to solve technical problems that need to be solved and provide a vacuum pump that can decompose by-products into particles using radicals and effectively discharge the by-products to outside.

The present invention has been proposed to achieve the above object. The invention according to claim 1 provides a vacuum pump including: a housing having an inlet port and an outlet port; a rotor shaft rotationally supported inside the housing; and a rotating body including a rotor blade fixed to the rotor shaft and is rotatable together with the rotor shaft, the vacuum pump further including: at least one radical supply port capable of supplying a plurality of types of radicals into the housing; and a radical supply means for supplying the radicals to the radical supply port.

According to this configuration, when the reaction with a single type of radicals cannot achieve decomposition into particles, radicals of a plurality of types may be supplied from the radical supply ports of the radical supply means. Thus, deposits made of by-products that are decomposable into particles in steps using a plurality of types of radicals can be effectively decomposed into particles and discharged.

The invention according to claim 2 provides the vacuum pump according to claim 1, wherein the radical supply means includes a radical generation source adapted to generate the different types of radicals and a power supply configured to drive the radical generation source.

According to this configuration, the radical supply means has the radical generation source adapted to generate different types of radicals and the power supply configured to drive the radical generation source. The radical generation source adapted to generate different types of radicals and the power supply configured to drive the radical generation source generate the different types of radicals. Thus, deposits made of by-products that are decomposable into particles in steps using a plurality of types of radicals can be effectively decomposed into particles and discharged.

The invention according to claim 3 provides the vacuum pump according to claim 2, wherein at least a part of the power supply configured to drive the radical generation source of the different types of radicals serves also as a power supply for pump control.

Power supplies are required to drive different types of radical generation sources, but a plurality of power supplies may cause problems of cost increase and space shortage. This configuration can achieve advantageous effects of cost reduction and space saving, with by also using at least a part of the power supply serving also as the power supply for pump control.

The invention according to claim. 4 provides the vacuum pump according to claim 2, wherein at least a part of the power supply configured to drive the radical generation source for the different types of radicals serves also as a power supply for plasma generation of a chamber.

Power supplies are required to drive different types of radical generation sources, but a plurality of power supplies may cause problems of cost increase and space shortage. This configuration can achieve advantageous effects of cost reduction and space saving, with at least a part of the power supply serving also as the power supply for plasma generation of the chamber.

The invention according to claim 5 provides the vacuum pump according to any one of claims 2 to 4, wherein the radical generation source has a replaceable electrode, the power supply for the radical generation source has a voltage output variable function, and generation of various types of radicals is achievable by replacing the electrode and adjusting a voltage output of the power supply.

According to this configuration, the radical generation source has a changeable electrode, the power supply for the radical generation source has a voltage output variable function, and the generation of various types of radicals is achievable by replacing the electrode and adjusting the voltage output of the power supply.

The invention according to claim 6 provides the vacuum pump according to any one of claims 1 to 5, wherein the radical supply means is provided correspondingly to each of the radical supply ports and includes a valve capable of controlling supply of the radicals supplied from each of the radical supply ports.

According to this configuration, the amount of radicals supplied from each radical supply port is controlled by the valve provided corresponding to the radical supply port, and the required amount of radicals is supplied from each radical supply port.

The invention according to claim 7 provides the vacuum pump according to any one of claims 1 to 6, wherein each of the radical supply ports is located at a position substantially equidistant from the inlet port in an axial direction of the rotor shaft.

According to this configuration, each of the radical supply ports is located at a position substantially equidistant from the inlet port in the axial direction, facilitating the adjustment of the amount and timing of supply of radicals from each radical supply port.

The invention according to claim 8 provides the vacuum pump according to any one of claims 1 to 6, further including a controller configured to control opening and closing of the valve.

According to this configuration, the amount and timing of supply of radicals from each radical supply port can be easily adjusted through the controller. Also, the controller can receive a signal from an external device (such as a semiconductor manufacturing apparatus) and freely supply radicals into the vacuum pump.

The invention according to claim 9 provides the vacuum pump according to claim 8, wherein the controller is configured to control opening and closing of the valve, based on operation data representing an operation status of the vacuum pump.

According to this configuration, the controller itself can determine the state of the vacuum pump from the operation data of the vacuum pump and automatically supply radicals into the vacuum pump.

The invention according to claim 10 provides the vacuum pump according to claim 9, wherein the controller is configured to, when a current value of a motor for driving and rotating the rotor shaft as the operation data exceeds a predetermined threshold value, determine that deposition of by-products is in progress and that the radicals need to be supplied to clean off the by-products.

According to this configuration, when the current value of the motor for driving and rotating the rotor shaft as the operation data exceeds the predetermined threshold value, the controller determines that deposition of by-products is in progress and that the radicals need to be supplied to clean off the by-products. Thus, the radicals are automatically supplied into the vacuum pump.

The invention according to claim 11 provides the vacuum pump according to claim 9, wherein the controller is configured to, when a current value of a motor for driving and rotating the rotor shaft as the operation data is substantially equal to a pre-stored current value of the motor in no-load operation, control opening and closing control of the valve.

According to this configuration, the controller itself compares the current value of the motor in no-load operation of the turbomolecular pump with the current value of the turbomolecular pump at the present time, determines that there is no inflow of the process gas when the current value at the present time is substantially equal to the current value of the motor in no-load operation, and therefore automatically supply radicals into the vacuum pump.

The invention according to claim 12 provides the vacuum pump according to claim 9, wherein the controller is configured to, when a pressure value of the vacuum pump as the operation data exceeds a predetermined threshold value, determine that deposition of by-products is in progress and that the radicals need to be supplied to clean off the by-products.

According to this configuration, the controller itself identifies the state of deposition of the by-products in the vacuum pump based on the pressure value of the vacuum pump and determines whether radicals need to be supplied into the vacuum pump to clean off the by-products. When radicals need to be supplied, radicals are automatically supplied into the turbomolecular pump.

The invention according to claim 13 provides the vacuum pump according to claim 9, wherein the controller is configured to, when a pressure value of the vacuum pump as the operation data is substantially equal to a pre-stored pressure value of the vacuum pump in no-load operation, control opening and closing of the valve.

According to this configuration, the controller itself compares the pressure value of the turbomolecular pump in no-load operation with the pressure value of the turbomolecular pump at the present time, determines that there is no inflow of the process gas when the pressure value at the present time is substantially equal to the pressure value of the turbomolecular pump in no-load operation, and therefore automatically supply radicals into the vacuum pump.

The invention according to claim 14 provides a vacuum pump cleaning system including: a housing having an inlet port and an outlet port; a rotor shaft rotationally supported inside the housing; and a rotating body including a rotor blade fixed to the rotor shaft and is rotatable together with the rotor shaft, the vacuum pump cleaning system further including at least one radical supply means capable of supplying a plurality of types of radicals into the housing.

According to this system configuration, when the reaction with a single type of radicals cannot achieve decomposition into particles, radicals of a plurality of types may be supplied from the radical supply ports of the radical supply means. Thus, deposits made of by-products that are decomposable into particles in steps using a plurality of types of radicals can be effectively decomposed into particles and discharged.

According to the invention, since the radical supply ports capable of supplying a plurality of types of radicals into the housing and the radical supply means configured to supply the radicals to the radical supply ports are provided, when the reaction with a single type of radicals cannot achieve decomposition into particles, radicals of a plurality of types may be supplied from the radical supply ports of the radical supply means. Thus, deposits made of by-products that are decomposable into particles in steps using a plurality of types of radicals can be effectively decomposed into particles and discharged in a cleaning process.

Also, supplying radicals into the vacuum pump allows for the supply of an adequate amount of radicals required to cause the reaction of the by-products in the vacuum pump. This minimizes the deterioration of the material itself of the vacuum pump, and also minimizes the amount of gas required to be supplied to generate radicals.

Some of the particles that have been decomposed into particles by reaction with radicals may move back toward the inlet port (toward the chamber). However, when the radical supply ports are closer to the outlet port than the stator blade that is the closest to the inlet port in the axial direction of the rotor shaft, some of the particles moving toward the inlet port collide with the stator blade closer to the inlet port and are thus prevented from moving toward the inlet port. This limits the return of some particles to the inlet port side, thereby reducing the defect rate of the semiconductor manufacturing apparatus or the like.

Moreover, the radicals decompose the by-products into particles, allowing them to be discharged from the vacuum pump. This eliminates the need for stopping the semiconductor manufacturing apparatus or the like to clean, repair, or replace the vacuum pump. As a result, not only an improvement in the production efficiency of semiconductors, but also reductions in the cleaning, repair, and replacement costs are achievable.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a vertical cross-sectional view of a turbomolecular pump as an example of a vacuum pump according to an embodiment of the present invention;

FIG. 2 is a diagram showing an example of an amplifier circuit in the turbomolecular pump;

FIG. 3 is a time chart showing an example of control performed when a current command value detected by the amplifier circuit in the turbomolecular pump is greater than a detected value;

FIG. 4 is a time chart showing an example of control performed when a current command value detected by the amplifier circuit in the turbomolecular pump is less than a detected value;

FIG. 5 is a time chart illustrating an example of control by a controller of the turbomolecular pump;

FIG. 6 is a schematic view illustrating the advantageous effect of the arrangement position of a radical supply port of the turbomolecular pump; and

FIG. 7 is a vertical cross-sectional view of a turbomolecular pump as another example of a vacuum pump according to an embodiment of the present invention.

### DETAILED DESCRIPTION

To achieve the object of providing a vacuum pump that can effectively discharge by-products by decomposing the by-products into particles using radicals, the present invention is directed to a vacuum pump including: a housing having an inlet port and an outlet port; a rotor shaft rotationally supported inside the housing; a rotating body that includes a plurality of rotor blades fixed to the rotor shaft and is rotatable with the rotor shaft; at least one radical supply port capable of supplying a plurality of types of radicals into the housing; and a radical supply means configured to supply the radicals to the radical supply port.

### Examples

Referring to the accompanying drawings, examples according to embodiments of the present invention are described in detail. In the following examples, when reference is made to the number, numerical value, amount, range, or the like of components, it is not limited to the specific number, and may be greater than or less than the specific number, unless specified otherwise or clearly limited to the specific number in principle.

Also, when reference is made to the shape and positional relationship of components and the like, those that are substantially analogous or similar to the shape and the like are included unless specified otherwise or the content clearly dictates otherwise in principle.

In the drawings, characteristic parts may be enlarged or otherwise exaggerated to improve understanding of the characteristics, and components are not necessarily drawn to scale. In cross-sectional views, hatch patterns of some components may be omitted to improve understanding of the cross-sectional structure of the components.

In the following description, the expressions indicating directions, such as up, down, left, and right, are not absolute and are appropriate when the portions of the turbomolecular pump of the present invention are in the orientation shown in the drawing, and should be interpreted with a change according to any change in the orientation. Additionally, the same elements are designated by the same reference numerals throughout the description of the examples.

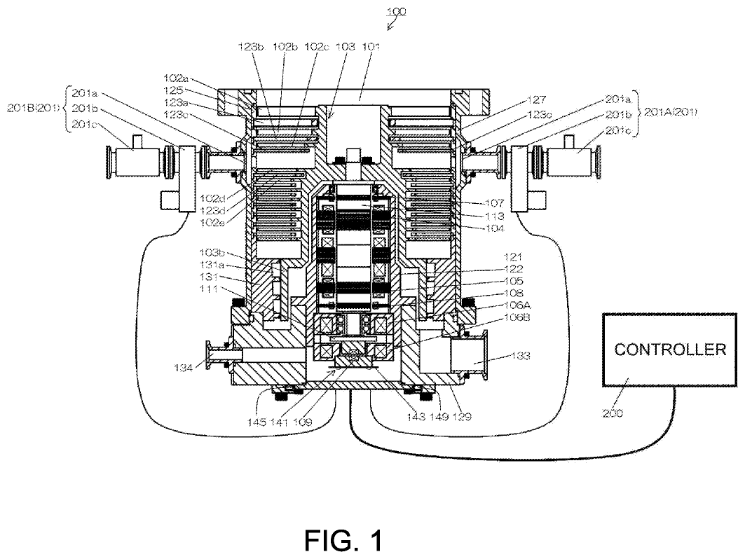

FIG. 1 is a vertical cross-sectional view showing an example of a turbomolecular pump 100 as a vacuum pump according to the present invention. In the following description, as viewed in FIG. 1, the left side in the right-left direction is defined as the front side in the front-rear direction of the apparatus, the right is defined as the rear side, the up-down directions are defined as up and down, and the directions perpendicular to the drawing plane are defined as left and right.

As shown in FIG. 1, the turbomolecular pump 100 has a circular outer cylinder 127 as a housing having an inlet port 101 at its upper end. A rotating body 103 in the outer cylinder 127 includes a plurality of rotor blades 102 (102a, 102b, 102c, . . . ), which are turbine blades for gas suction and exhaustion, in its outer circumference section. The rotor blades 102 extend radially in multiple stages. The rotating body 103 has a rotor shaft 113 in its center. The rotor shaft 113 is suspended in the air and position-controlled by a magnetic bearing of 5-axis control, for example.

Upper radial electromagnets 104 include four electromagnets arranged in pairs on an X-axis and a Y-axis. Four upper radial sensors 107 are provided in close proximity to the upper radial electromagnets 104 and associated with the respective upper radial electromagnets 104. Each upper radial sensor 107 may be an inductance sensor or an eddy current sensor having a conduction winding, for example, and detects the position of the rotor shaft 113 based on a change in the inductance of the conduction winding, which changes according to the position of the rotor shaft 113. The upper radial sensors 107 are configured to detect a radial displacement of the rotor shaft 113, that is, the rotating body 103 fixed to the rotor shaft 113, and send it to the controller 200.

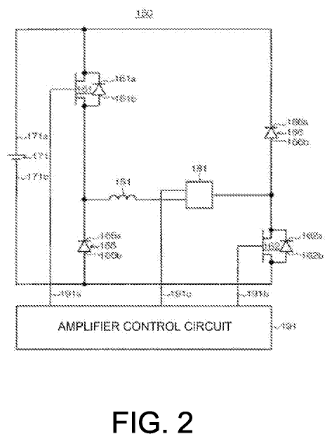

In the controller 200, for example, a compensation circuit having a PID adjustment function generates an excitation control command signal for the upper radial electromagnets 104 based on a position signal detected by the upper radial sensors 107. Based on this excitation control command signal, an amplifier circuit 150 (described below) shown in FIG. 2 controls and excites the upper radial electromagnets 104 to adjust a radial position of an upper part of the rotor shaft 113.

The rotor shaft 113 may be made of a high magnetic permeability material (such as iron and stainless steel) and is configured to be attracted by magnetic forces of the upper radial electromagnets 104. The adjustment is performed independently in the X-axis direction and the Y-axis direction. Lower radial electromagnets 105 and lower radial sensors 108 are arranged in a similar manner as the upper radial electromagnets 104 and the upper radial sensors 107 to adjust the radial position of the lower part of the rotor shaft 113 in a similar manner as the radial position of the upper part.

Additionally, axial electromagnets 106A and 106B are arranged so as to vertically sandwich a metal disc 111, which has a shape of a circular disc and is provided in the lower part of the rotor shaft 113. The metal disc 111 is made of a high magnetic permeability material such as iron. An axial sensor 109 is provided to detect an axial displacement of the rotor shaft 113 and send an axial position signal to the controller 200.

In the controller 200, the compensation circuit having the PID adjustment function may generate an excitation control command signal for each of the axial electromagnets 106A and 106B based on the signal on the axial position detected by the axial sensor 109. Based on these excitation control command signals, the amplifier circuit 150 controls and excites the axial electromagnets 106A and 106B separately so that the axial electromagnet 106A magnetically attracts the metal disc 111 upward and the axial electromagnet 106B attracts the metal disc 111 downward. The axial position of the rotor shaft 113 is thus adjusted.

As described above, the controller 200 appropriately adjusts the magnetic forces exerted by the axial electromagnets 106A and 106B on the metal disc 111, magnetically levitates the rotor shaft 113 in the axial direction, and suspends the rotor shaft 113 in the air in a non-contact manner. The amplifier circuit 150, which controls and excites the upper radial electromagnets 104, the lower radial electromagnets 105, and the axial electromagnets 106A and 106B, is described below.

The motor 121 includes a plurality of magnetic poles circumferentially arranged to surround the rotor shaft 113. Each magnetic pole is controlled by the controller 200 so as to drive and rotate the rotor shaft 113 via an electromagnetic force acting between the magnetic pole and the rotor shaft 113. The motor 121 also includes a rotational speed sensor (not shown), such as a Hall element, a resolver, or an encoder, and the rotational speed of the rotor shaft 113 is detected based on a detection signal of the rotational speed sensor.

Furthermore, a phase sensor (not shown) is attached adjacent to the lower radial sensors 108 to detect the phase of rotation of the rotor shaft 113. The controller 200 detects the position of the magnetic poles using both detection signals of the phase sensor and the rotational speed sensor.

A plurality of stator blades 123a, 123b, 123c, 123d, . . . are arranged slightly spaced apart from the rotor blades 102 (102a, 102b, 102c, 102d, . . . ). Each rotor blade 102 (102a, 102b, 102c, 102d, . . . ) is inclined by a predetermined angle from a plane perpendicular to the axis of the rotor shaft 113 in order to transfer exhaust gas molecules downward through collision.

The stator blades 123 are also inclined by a predetermined angle from a plane perpendicular to the axis of the rotor shaft 113. The stator blades 123 extend inward of the outer cylinder 127 and alternate with the stages of the rotor blades 102. The outer circumference ends of the stator blades 123 are inserted between and thus supported by a plurality of layered stator blade spacers 125 (125a, 125b, 125c, 125d, . . . ).

The stator blade spacers 125 are ring-shaped members made of a metal, such as aluminum, iron, stainless steel, or copper, or an alloy containing these metals as components, for example. The outer cylinder 127 is fixed to the outer circumferences of the stator blade spacers 125 with a slight gap. A base portion 129 is located at the base of the outer cylinder 127. The base portion 129 has an outlet port 133 and a purge gas supply port 134 providing communication to the outside. The exhaust gas transferred to the base portion 129 through the inlet port 101 from the chamber side and the radicals transferred from a radical supply port 201a, which is described below, are sent to the outlet port 133.

According to the application of the turbomolecular pump 100, a threaded spacer 131 may be provided between the lower part of the stator blade spacer 125 and the base portion 129. The threaded spacer 131 is a cylindrical member made of a metal such as aluminum, copper, stainless steel, or iron, or an alloy containing these metals as components. The threaded spacer 131 has a plurality of helical thread grooves 131a in its inner circumference surface. When exhaust gas molecules move in the rotation direction of the rotating body 103, these molecules are transferred toward the outlet port 133 in the direction of the helix of the thread grooves 131a.

In the lowermost section of the rotating body 103 below the rotor blades 102 (102a, 102b, 102c, . . . ), a cylindrical portion 103b extends downward. The outer circumference surface of the cylindrical portion 103b is cylindrical and projects toward the inner circumference surface of the threaded spacer 131. The outer circumference surface is adjacent to but separated from the inner circumference surface of the threaded spacer 131 by a predetermined gap. The exhaust gas transferred to the thread grooves 131a by the rotor blades 102 and the stator blades 123 is guided by the thread grooves 131a to the base portion 129.

The base portion 129 is a disc-shaped member forming the base section of the turbomolecular pump 100, and is generally made of a metal such as iron, aluminum, or stainless steel. The base portion 129 physically holds the turbomolecular pump 100 and also serves as a heat conduction path. As such, the base portion 129 is preferably made of rigid metal with high thermal conductivity, such as iron, aluminum, or copper.

According to the application of the turbomolecular pump 100, a plurality of radical supply means 201 is provided between a stator blade spacer 125 and a rotor blade 102. Each radical supply means 201 includes a radical supply port 201a, a radical supply valve 201b, and a radical generation source 201c. The present example has two radical supply means 201 of a radical supply means 201A and a radical supply means 201B, but it is sufficient that at least one radical supply means 201 is provided.

The radical supply port 201a of each radical supply means 201 (201A, 201B) is closer to the outlet port 133 than at least the stator blade 102a that is the closest to the inlet port 101 in the axial direction of the rotating body 103 (up-down direction of the turbomolecular pump 100 as viewed in FIG. 1), that is, between a stator blade 123c and a rotor blade 102d in the example of FIG. 1. Thus, the radical supply ports 201a of the radical supply means 201 have the same height position relative to the inlet port 101, that is, they are positioned substantially equidistant from the inlet port 101 in the axial direction and spaced at substantially equal intervals in the rotational direction. The radical supply ports 201a are arranged substantially parallel to the rotor blades 102 and the stator blades 123 such that they supply radicals in the directions toward the axis of the rotating body 103. Thus, radicals are blown out toward the axis of the rotating body 103 from each radical supply port 201a. As the radicals to be blown out from the radical supply ports 201a, a plurality of types of radicals are provided to effectively decompose the deposits made of by-products that are decomposable into particles in steps using a plurality of types of radicals and to discharge the particles from the outlet port 133 together with the radicals. To this end, the present example is configured such that the radical supply ports 201a supply mutually different types of radicals. When only a single type of radicals is required, the same type of radicals may be supplied from the radical supply ports 201a. Even when different types of radicals need to be supplied, a single radical supply port 201a may also be used to supply different types of radicals, allowing the number of radical supply ports 201a to be reduced.

The radical supply valve 201b of each radical supply means 201 is arranged between the radical supply port 201a and the radical generation source 201c. Each radical supply valve 201b can adjust the amount of radicals supplied from the corresponding radical generation source 201c to the radical supply port 201a. The controller 200 controls opening and closing of each radical supply valve 201b. The controller 200 is mainly composed of a microcomputer. The controller 200 is formed as a unit of various control circuits and a built-in program that enables control of the entire turbomolecular pump 100 according to a predetermined procedure.

To decompose the by-products that are decomposable into particles in steps using a plurality of types of radicals as described above, the radical generation sources 201c of the radical supply means 201 are set to supply mutually different types of radicals according to the intended by-products. However, when the deposits can be decomposed into particles with a single type of radicals, all radical generation sources 201c may supply the same type of radicals.

The amplifier circuit 150 is now described that controls and excites the upper radial electromagnets 104, the lower radial electromagnets 105, and the axial electromagnets 106A and 106B of the turbomolecular pump 100 configured as described above. FIG. 2 is a circuit diagram of the amplifier circuit 150.

In FIG. 2, one end of an electromagnet winding 151 forming an upper radial electromagnet 104 or the like is connected to a positive electrode 171a of a power supply 171 via a transistor 161, and the other end is connected to a negative electrode 171b of the power supply 171 via a current detection circuit 181 and a transistor 162. Each transistor 161, 162 is a power MOSFET and has a structure in which a diode is connected between the source and the drain thereof.

In the transistor 161, a cathode terminal 161a of its diode is connected to the positive electrode 171a, and an anode terminal 161b is connected to one end of the electromagnet winding 151. In the transistor 162, a cathode terminal 162a of its diode is connected to a current detection circuit 181, and an anode terminal 162b is connected to the negative electrode 171b.

A diode 165 for current regeneration has a cathode terminal 165a connected to one end of the electromagnet winding 151 and an anode terminal 165b connected to the negative electrode 171b. Similarly, a diode 166 for current regeneration has a cathode terminal 166a connected to the positive electrode 171a and an anode terminal 166b connected to the other end of the electromagnet winding 151 via the current detection circuit 181. The current detection circuit 181 may include a Hall current sensor or an electric resistance element, for example.

The amplifier circuit 150 configured as described above corresponds to one electromagnet. Accordingly, when the magnetic bearing uses 5-axis control and has ten electromagnets 104, 105, 106A, and 106B in total, an identical amplifier circuit 150 is configured for each of the electromagnets. These ten amplifier circuits 150 are connected to the power supply 171 in parallel.

An amplifier control circuit 191 may be formed by a digital signal processor portion (not shown, hereinafter referred to as a DSP portion) of the controller 200. The amplifier control circuit 191 switches the transistors 161 and 162 between on and off.

The amplifier control circuit 191 is configured to compare a current value detected by the current detection circuit 181 (a signal reflecting this current value is referred to as a current detection signal 191c) with a predetermined current command value. The result of this comparison is used to determine the magnitude of the pulse width (pulse width time Tp1, Tp2) generated in a control cycle Ts, which is one cycle in PWM control. As a result, gate drive signals 191a and 191b having this pulse width are output from the amplifier control circuit 191 to gate terminals of the transistors 161 and 162.

Under certain circumstances such as when the rotational speed of the rotating body 103 reaches a resonance point during acceleration, or when a disturbance occurs during a constant speed operation, the rotating body 103 may require positional control at high speed and with a strong force. For this purpose, a high voltage of about 50 V, for example, is used for the power supply 171 to enable a rapid increase (or decrease) in the current flowing through the electromagnet winding 151. Additionally, a capacitor is generally connected between the positive electrode 171a and the negative electrode 171b of the power supply 171 to stabilize the power supply 171 (not shown).

In this configuration, when both transistors 161 and 162 are turned on, the current flowing through the electromagnet winding 151 (hereinafter referred to as an electromagnet current iL) increases, and when both are turned off, the electromagnet current iL decreases.

Also, when one of the transistors 161 and 162 is turned on and the other is turned off, a freewheeling current is maintained. Passing the freewheeling current through the amplifier circuit 150 in this manner reduces the hysteresis loss in the amplifier circuit 150, thereby limiting the power consumption of the entire circuit to a low level. Moreover, by controlling the transistors 161 and 162 as described above, high frequency noise, such as harmonics, generated in the turbomolecular pump 100 can be reduced. Furthermore, by measuring this freewheeling current with the current detection circuit 181, the electromagnet current iL flowing through the electromagnet winding 151 can be detected.

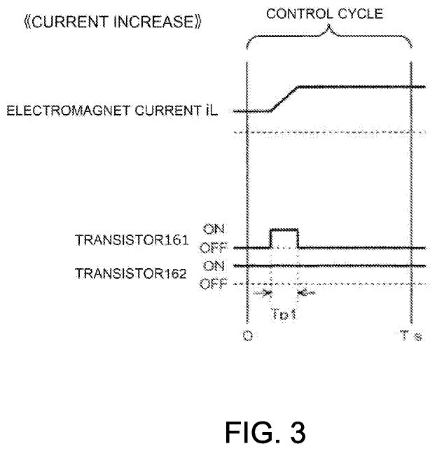

That is, when the detected current value is smaller than the current command value, as shown in FIG. 3, the transistors 161 and 162 are simultaneously on only once in the control cycle Ts (for example, 100 μs) for the time corresponding to the pulse width time Tp1. During this time, the electromagnet current iL increases accordingly toward the current value iLmax (not shown) that can be passed from the positive electrode 171a to the negative electrode 171b via the transistors 161 and 162.

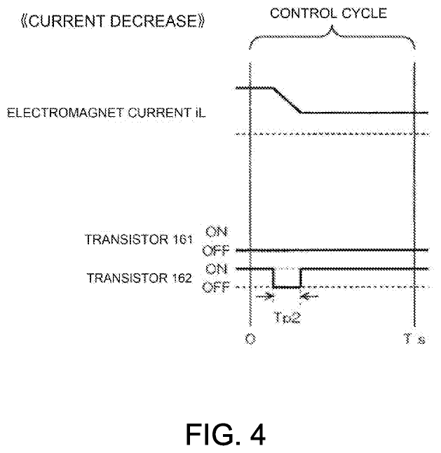

When the detected current value is larger than the current command value, as shown in FIG. 4, the transistors 161 and 162 are simultaneously off only once in the control cycle Ts for the time corresponding to the pulse width time Tp2. During this time, the electromagnet current iL decreases accordingly toward the current value iLmin (not shown) that can be regenerated from the negative electrode 171b to the positive electrode 171a via the diodes 165 and 166.

In either case, after the pulse width time Tp1, Tp2 has elapsed, one of the transistors 161 and 162 is on. During this period, the freewheeling current is thus maintained in the amplifier circuit 150.

In this configuration, when the motor 121 drives and rotates the rotor blades 102 together with the rotor shaft 113, the interaction between the rotor blades 102 and the stator blades 123 causes the suction of exhaust gas from the chamber through the inlet port 101. The exhaust gas taken through the inlet port 101 moves between the rotor blades 102 and the stator blades 123 and is transferred to the base portion 129. At this time, factors such as the friction heat generated when the exhaust gas comes into contact with the rotor blades 102 and the conduction of heat generated by the motor 121 increase the temperature of the rotor blades 102. This heat is conducted to the stator blades 123 through radiation or conduction via gas molecules of the exhaust gas, for example.

The stator blade spacers 125 are joined to each other at the outer circumference portion and conduct the heat received by the stator blades 123 from the rotor blades 102, the friction heat generated when the exhaust gas comes into contact with the stator blades 123, and the like to the outside.

In the above description, the threaded spacer 131 is provided at the outer circumference of the cylindrical portion 103b of the rotating body 103, and the thread grooves 131a are engraved in the inner circumference surface of the threaded spacer 131. However, this may be inversed in some cases, and a thread groove may be engraved in the outer circumference surface of the cylindrical portion 103b, while a spacer having a cylindrical inner circumference surface may be arranged around the outer circumference surface.

According to the application of the turbomolecular pump 100, to prevent the gas drawn through the inlet port 101 from entering an electrical portion, which includes the upper radial electromagnets 104, the upper radial sensors 107, the motor 121, the lower radial electromagnets 105, the lower radial sensors 108, the axial electromagnets 106A, 106B, and the axial sensor 109, the electrical portion may be surrounded by a stator column 122. The inside of the stator column 122 may be maintained at a predetermined pressure by the purge gas supplied from the purge gas supply port 134.

For example, the supplied purge gas is sent to the outlet port 133 through gaps between a protective bearing 120 and the rotor shaft 113, between the rotor and the stator of the motor 121, and between the stator column 122 and the inner circumference cylindrical portion of the rotor blade 102.

The turbomolecular pump 100 requires the identification of the model and control based on individually adjusted unique parameters (for example, various characteristics associated with the model). To store these control parameters, the turbomolecular pump 100 includes an electronic circuit portion 141 in its main body. The electronic circuit portion 141 may include a semiconductor memory, such as an EEPROM, electronic components such as semiconductor elements for accessing the semiconductor memory, and a substrate 143 for mounting these components. The electronic circuit portion 141 is housed under a rotational speed sensor (not shown) near the center, for example, of the base portion 129, which forms the lower part of the turbomolecular pump 100, and is closed by an airtight bottom lid 145.

Some process gas introduced into the chamber in the manufacturing process of semiconductors has the property of becoming solid when its pressure becomes higher than a predetermined value or its temperature becomes lower than a predetermined value. In the turbomolecular pump 100, the pressure of the exhaust gas is lowest at the inlet port 101 and highest at the outlet port 133. When the pressure of the process gas increases beyond a predetermined value or its temperature decreases below a predetermined value while the process gas is being transferred from the inlet port 101 to the outlet port 133, the process gas is solidified, adheres, and accumulates as by-products on the inner side of the turbomolecular pump 100.

For example, when SiCl₄ is used as the process gas in an Al etching apparatus, according to the vapor pressure curve, a solid product (for example, AlCl₃) is deposited at a low vacuum (760 [torn] to 10⁻² [torr]]) and a low temperature (about 20 [ ° C.]) and adheres and accumulates on the inner side of the turbomolecular pump 100. When the by-products of the process gas accumulate in the turbomolecular pump 100, the deposits may narrow the pump flow passage and degrade the performance of the turbomolecular pump 100. The above-mentioned product tends to solidify and adhere in areas with higher pressures, such as the vicinity of the outlet port and the vicinity of the threaded spacer 131.

To solve this problem, conventionally, a heater or annular water-cooled tube 149 (not shown) is wound around the outer circumference of the base portion 129, and a temperature sensor (e.g., a thermistor, not shown) is embedded in the base portion 129, for example. The signal of this temperature sensor is used to perform control to maintain the temperature of the base portion 129 at a constant high temperature (preset temperature) by heating with the heater or cooling with the water-cooled tube 149 (hereinafter referred to as TMS (temperature management system)).

With the turbomolecular pump 100, the gas solidifies also in the process of compressing process gas in the turbomolecular pump 100 and accumulates on the inner side of the outer cylinder 127. For this reason, the controller 200 drives, between processing steps, the radical supply means 201 to supply radicals from the radical supply ports 201a into the outer cylinder 127 while adjusting the opening and closing of the radical supply valves 201b to allow the radicals to flow toward the outlet port 133. The accumulated by-products are decomposed into particles by reaction with the radicals and discharged to the outside of the outer cylinder 127 through the outlet port 133 together with the radicals.

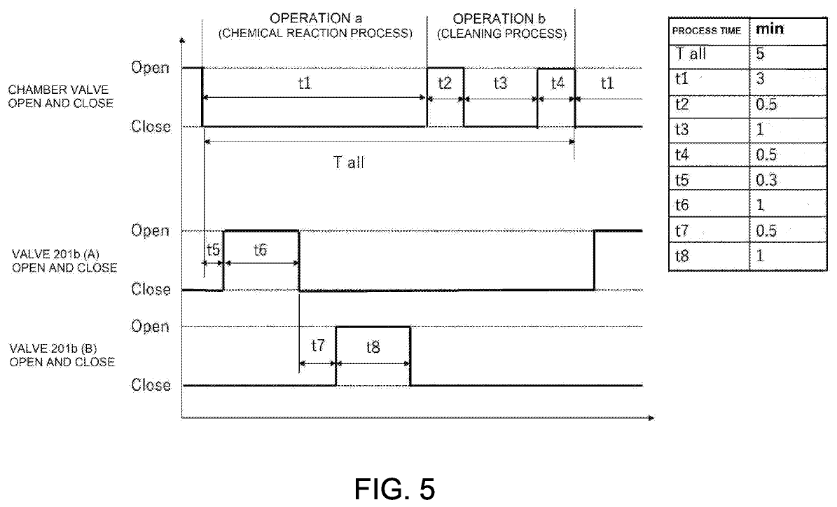

FIG. 5 shows an example of operation of the controller 200. FIG. 5 is a timing chart showing the opening and closing action of a chamber valve (not shown) provided between the chamber and the turbomolecular pump 100, the opening and closing action of the radical supply valve 201b of the radical supply means 201A shown in FIG. 1, and the opening and closing action of the radical supply valve 201b of the radical supply means 201B. In FIG. 5, the Y-axis represents the amount of opening and closing action, and the X-axis represents process time T. The operation of the controller 200 is now described referring to the timing chart of FIG. 5.

The controller 200 decomposes the accumulated by-products in the turbomolecular pump 100 into particles to perform a discharge process during Operation a in which a chemical reaction process such as etching is performed on wafers in the chamber.

In this discharge process, the chamber valve (not shown) is changed from Open to Close so that the process gas from the chamber does not flow into the turbomolecular pump 100. When the chamber valve is confirmed to be closed, Operation a starts in the chamber. Then, when time t5 (0.3 minutes) has passed since the chamber valve is closed, the radical supply valve 201b of the radical supply means 201A is switched from Close to Open, and the radical supply valve 201b is held in Open for time t6 (1 minute), for example. While the radical supply valve 201b is in Open, radicals of type A are supplied from the radical generation source 201c, and the radicals of type A (for example, 0 radicals) are supplied into the outer cylinder 127 from the radical supply port 201a of the radical supply means 201A. When there is a time sufficient to change the motor rotational speed in supplying the radicals, the controller 200, which controls the driving of the motor 121, may change the rotational speed of the motor 121 to a rotational speed less than the rated rotational speed to drive the rotating body 103 at a low speed. Then, radicals of type A are supplied into the outer cylinder 127 while the rotating body 103 is rotating.

The type A radicals supplied into the outer cylinder 127 from the radical supply port 201a of the radical supply means 201A flow in the outer cylinder 127 through the gaps between the rotor blades 102 and the stator blades 123 toward the outlet port 133, and are discharged out of the outer cylinder 127 through the outlet port 133. Also, when the type A radicals flow through the gaps between the rotor blades 102 and the stator blades 123, the type A radicals coming into contact with the deposits accumulating in the outer cylinder 127 apply significant energy to the deposits that react with the type A radicals. This forcibly breaks the molecular chains in the surfaces of the deposits and decomposes the deposits into particulate gas of low molecular weight. Then, the gas decomposed into low-molecular-weight particles by the type A radicals is discharged to the outside through the outlet port 133 together with the radicals.

Upon completion of the supply of the type A radicals into the outer cylinder 127 from the radical supply port (A) 201a of the radical supply means 201A for time t6 (1 minute), the radical supply valve 201b of the radical supply means 201A is switched from Open to Close again, and the supply of the type A radicals into the outer cylinder 127 from the radical supply port 201a is stopped.

After the radical supply valve 201b of the radical supply means 201A is switched to Close, the radical supply valve (B) 201b of the radical supply means 201B is switched from Close to Open after time t7 (0.5 minutes), and the radical supply valve 201b of the radical supply means 201B is kept in Open for time t8 (1 minute), for example. While the radical supply valve 201b of the radical supply means 201B is in Open, radicals of type B (e.g., F radicals) are supplied into the outer cylinder 127 from the radical generation source 201c of the radical supply means 201B through the radical supply port 201a. When there is a time sufficient to change the motor rotational speed in supplying the radicals of type B, the controller 200, which controls the driving of the motor 121, may also change the rotational speed of the motor 121 to a rotational speed less than the rated rotational speed to drive the rotating body 103 at a low speed. Then, radicals of type B are supplied into the outer cylinder 127 while the rotating body 103 is rotating.

The type B radicals supplied into the outer cylinder 127 from the radical supply port 201a of the radical supply means 201B flow in the outer cylinder 127 through the gaps between the rotor blades 102 and the stator blades 123 toward the outlet port 133, and are discharged out of the outer cylinder 127 through the outlet port 133. Also, when the type B radicals flow through the gaps between the rotor blades 102 and the stator blades 123, the type B radicals coming into contact with the deposits accumulating in the outer cylinder 127 apply significant energy to the deposits that react with the type B radicals. This forcibly breaks the molecular chains in the surfaces of the deposits and decomposes the deposits into particulate gas of low molecular weight. Then, the gas decomposed into low-molecular-weight particles by the type B radicals is discharged to the outside through the outlet port 133 in the same manner as the radical supply means 201A.

Upon completion of the supply of the type B radicals into the outer cylinder 127 from the radical supply port 201a of the radical supply means 201B for time t8 (1 minute), the radical supply valve 201b of the radical supply means 201B is switched from Open to Close again, and the supply of the type B radicals into the outer cylinder 127 from the radical supply port 201a is stopped.

As a result, the deposits in the outer cylinder 127 are decomposed into particles by the radicals of type A and the radicals of type B so as to be removed and reduced.

At substantially the same time as when the radical supply valve 201b of the radical supply means 201B is switched from Open to Close, Operation a for time t1 (3 minutes) within the chamber also ends.

Then, Operation b, such as a wafer cleaning process, starts in the chamber. In Operation b, the chamber valve is opened for time t2 (0.5 minutes), then closed for time t3 (1 minute), and opened again for time t4 (0.5 minutes). While the chamber valve is open, the process gas in the chamber flows through the inlet port 101 of the turbomolecular pump 100 into the outer cylinder 127, and the process gas used in the chamber is compressed in the turbomolecular pump 100 (outer cylinder 127) and exhausted from the outlet port 133.

One cycle of the operation of the chamber and the operation of the turbomolecular pump 100 thus ends. A series of operations is repeated until the system is stopped.

The structure of the present example supplies radicals of a plurality of types A and B into the outer cylinder 127 by causing the type A radicals to flow from the radical supply port 201a of the radical supply means 201A and causing the type B radicals to flow from the radical supply port 201a of the radical supply means 201B. When the reaction with a single type (type A or type B) of radicals cannot achieve decomposition into particles, supplying the radicals of type A and type B from the respective radical supply ports 201a of the radical supply means 201A and 201B allows the by-products to first react with the type A radicals and subsequently with the type B radicals. This allows the deposits made of by-products that cannot be decomposed into particles by a single type of radicals to be effectively decomposed into gaseous particles and discharged in a cleaning process.

Also, supplying radicals into the turbomolecular pump 100 allows an adequate amount of radicals required to cause the reaction of the by-products to be supplied into the turbomolecular pump 100. This minimizes the deterioration of the material itself of the turbomolecular pump 100, and also minimizes the supply amount of gas required to generate radicals.

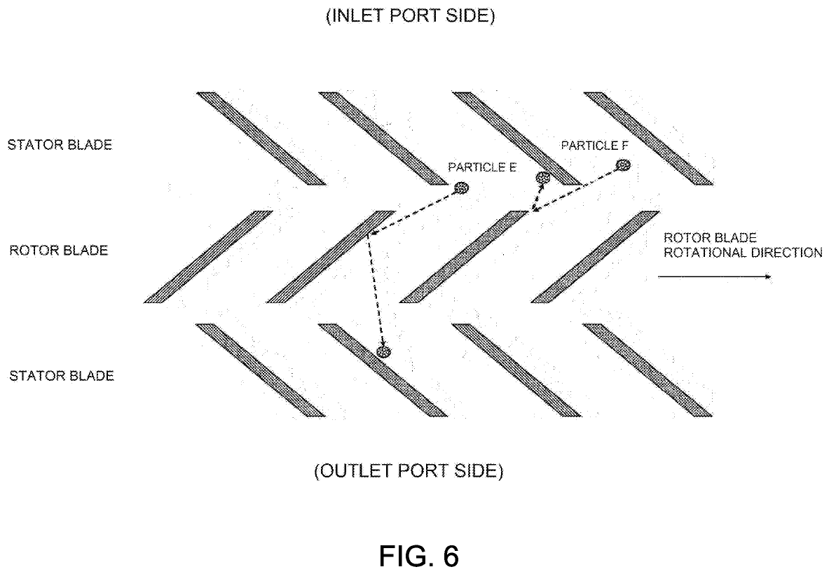

Additionally, as shown in FIG. 1, the radical supply ports 201a of the radical supply means 201A and 201B of the turbomolecular pump 100 of the present example are closer to the outlet port 133 than the stator blade 102a that is the closest to the inlet port 101 in the axial direction of the rotor shaft 113. That is, the radical supply ports 201a are provided between a stator blade 123c and a rotor blade 102d. FIG. 6 schematically shows movements of particles E and F resulting from reaction with radicals. Particle E collides with a rotor blade 102d and is guided downward toward the outlet port 133. Particle F, which is a part of particles colliding with the rotor blade 102d, is bounced back toward the inlet port 101 (chamber side). The bounced particle F then collides with the stator blade 123c closer to the inlet port 101 and is thus blocked from moving toward the inlet port 101. As a result, the particle F bounding off the rotor blade 102d toward the inlet port 101 does not flow back into the chamber or cause wafer defects or the like.

The radicals used for decomposition into particles can deteriorate components of the turbomolecular pump 100 (made mainly of aluminum, stainless steel, or the like). However, the present example has the radical supply ports 201a that are directly installed in the turbomolecular pump 100. This allows minimum necessary radicals to be directly supplied to the turbomolecular pump 100 without being affected by the configuration provided from the chamber to the outlet port 133.

The controller 200 controls opening and closing of the radical supply valves 201b to adjust the amount and timing of supply of radicals from the radical generation sources 201c through the radical supply ports 201a. As the control method of the controller 200, the following methods (1) to (5) are contemplated.

(1) The controller 200 controls the opening and closing of the radical supply valves 201b based on the operation data representing the operation status of the turbomolecular pump 100. With this control method, the controller 200 itself determines the state of the vacuum pump from the operation data of the turbomolecular pump 100 and automatically supply radicals into the vacuum pump.

(2) When the current value, which is the operation data representing the operation status of the turbomolecular pump 100, of the motor 121 for driving and rotating the rotor shaft 113 exceeds a predetermined threshold value, it is determined that deposition of by-products is in progress and that radicals need to be supplied to clean off the by-products. The controller 200 thus controls the opening and closing of the radical supply valve 201b. With this control method, when the current value, which is the operation data, of the motor 121 for driving and rotating the rotor shaft 113 exceeds the predetermined threshold value, the controller 200 determines that radicals need to be supplied and therefore automatically supplies radicals into the turbomolecular pump 100.

(3) When the current value, which is the operation data representing the operation status of the turbomolecular pump 100, of the motor 121 for driving and rotating the rotor shaft 113 is substantially equal to the pre-stored current value of the motor 121 in no-load operation, the controller 200 controls the opening and closing of the radical supply valve 201b. With this control method, the controller 200 compares the current value of the motor 121 in no-load operation of the turbomolecular pump 100 with the current value of the turbomolecular pump 100 at the present time and determines that there is no inflow of the process gas when the current value at the present time is substantially equal to the current value of the motor 121 in no-load operation. Thus, the turbomolecular pump by itself can determine whether to perform cleaning and automatically supply radicals into the turbomolecular pump 100.

(4) When the pressure value, which is the operation data representing the operation status of the turbomolecular pump 100, exceeds a predetermined threshold value, the controller 200 determines that deposition of by-products is in progress and that radicals need to be supplied to clean off the by-products. With this control method, the controller 200 uses the pressure value of the turbomolecular pump 100 to identify the state of the turbomolecular pump 100 and determine whether radicals need to be supplied. When radicals need to be supplied, radicals are automatically supplied into the turbomolecular pump 100.

(5) When the pressure value, which is the operation data representing the operation status of the turbomolecular pump 100, of the turbomolecular pump 100 is substantially equal to the pre-stored pressure value of the turbomolecular pump 100 in no-load operation, the opening and closing control of the valve is performed. With this control method, the controller 200 compares the pressure value of the turbomolecular pump 100 in no-load operation with the pressure value of the turbomolecular pump 100 at the present time and determines that there is no inflow of the process gas when the pressure value at the present time is substantially equal to the pressure value of the turbomolecular pump 100 in no-load operation. Thus, the turbomolecular pump by itself can determine whether to perform cleaning and automatically supply radicals into the turbomolecular pump 100.

The turbomolecular pump 100 of the first example supplies a plurality of types (type A and type B) of radicals. However, when only one type of radicals, radicals of type A or type B, are required to be supplied, the radical supply ports 201a may simultaneously supply the same type of radicals.

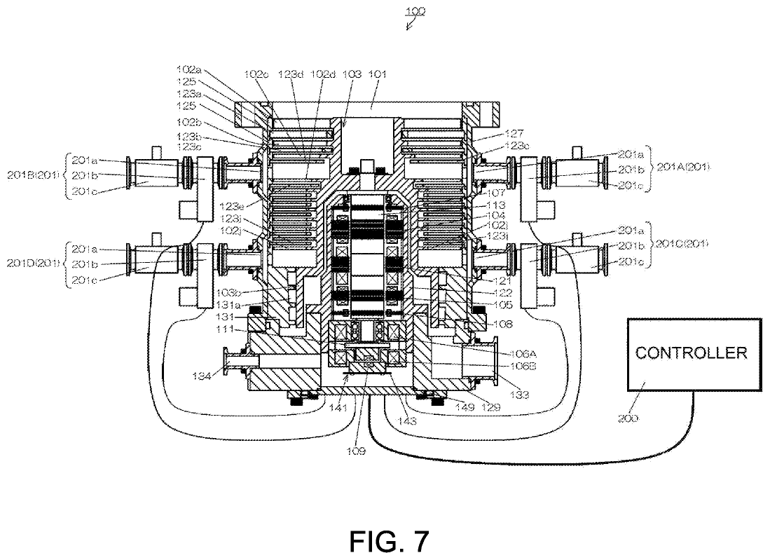

FIG. 7 is a vertical cross-sectional view showing another example of a turbomolecular pump 100 as a vacuum pump according to the present invention. The configuration of the embodiment shown in FIG. 7 includes, in addition to the radical supply means 201A and 201B of the turbomolecular pump 100 shown in FIG. 1, a lower radical supply means 201C and a lower radical supply means 201D, which are located below and separated by a predetermined amount from the radical supply means 201A and 201B in the axial direction of the rotor shaft 113. The configuration of the lower radical supply means 201C and 201D is generally the same as the configuration of the radical supply means 201A and 201B shown in FIG. 1 and differs only in the height position in the outer cylinder 127. As such, the same components are denoted by the same reference numerals, and redundant explanations are omitted.

In the turbomolecular pump 100 shown in FIG. 7 as a vacuum pump, the radical supply ports 201a of the upper radical supply means 201A and 201B are located between a stator blade 123c and a rotor blade 102d. This position is closer to the outlet port 133 than the stator blade 102a that is the closest to the inlet port 101 in the axial direction of the rotor shaft 113. The radical supply ports 201a of the lower radical supply means 201C and 201D are closer to the outlet port 133 than the rotor blade 102j that is the farthest from the inlet port 101 in the axial direction of the rotor shaft 113 and are located between the rotor blade 102j and the threaded spacer 131.

Under the control of the controller 200, the upper radical supply means 201A and 201B and the lower radical supply means 201C and 201D of the turbomolecular pump 100 shown in FIG. 7 cause the radicals of different types A, B, C, and D to flow in a predetermined order between Operations a to perform radical processing between Operations a in the same manner as shown in the timing chart of FIG. 5. Thus, deposits made of by-products that are decomposable into particles in steps using a plurality of types of radicals can be effectively decomposed into particles and discharged.

The example shown in FIG. 7 has the same advantageous effects as the example shown in FIG. 1. Also, some radicals have long-lasting effects, while other radicals have short-lasting effects. As such, a combination of two types of radicals, that is, type A and type B radicals with a long life (lifetime of persistence) and type C and type D radicals with a shorter life than the type A and type B radicals allows the type A, B, C, and D radicals to have corresponding lives and be efficiently used.

In the above examples, the power supply in a chamber of the semiconductor manufacturing apparatus may be shared as the radical generation power supply of the radical supply means 201A, 201B, 201C, and 201D. When the power supply in the chamber of the semiconductor manufacturing apparatus is shared as the radical generation power supply of the radical supply means 201A, 201B, 201C, and 201D, the number of power supplies is reduced. This may save cost or space.

It should be noted that the present invention is amenable to various modifications within the spirit of the invention, and the invention is intended to cover all modifications.

Although elements have been shown or described as separate embodiments above, portions of each embodiment may be combined with all or part of other embodiments described above. Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump comprising:
a housing having an inlet port and an outlet port;
a rotor shaft rotationally supported inside the housing; and
a rotating body including a rotor blade fixed to the rotor shaft and is rotatable together with the rotor shaft,
the vacuum pump further comprising:
at least one radical supply port capable of supplying a plurality of types of radicals into the housing; and
a radical supply means for supplying the radicals to the radical supply port.

2. The vacuum pump according to claim 1, wherein the radical supply means includes a radical generation source adapted to generate the plurality of types of radicals and a power supply configured to drive the radical generation source.

3. The vacuum pump according to claim 2, wherein at least a part of the power supply configured to drive the radical generation source for the plurality of types of radicals serves also as a power supply for pump control.

4. The vacuum pump according to claim 2, wherein at least a part of the power supply configured to drive the radical generation source for the plurality of types of radicals serves also as a power supply for plasma generation of a chamber.

5. The vacuum pump according to claim 2, wherein the radical generation source has a replaceable electrode, the power supply for the radical generation source has a voltage output variable function, and generation of various types of radicals is achievable by replacing the electrode and adjusting a voltage output of the power supply.

6. The vacuum pump according to claim 1, wherein the radical supply means is provided correspondingly to each of the radical supply ports and includes a valve capable of controlling supply of the radicals supplied from each of the radical supply ports.

7. The vacuum pump according to claim 1, wherein each of the radical supply ports is located at a position substantially equidistant from the inlet port in an axial direction of the rotor shaft.

8. The vacuum pump according to claim 6, further comprising a controller configured to control opening and closing of the valve.

9. The vacuum pump according to claim 8, wherein the controller is configured to control opening and closing of the valve, based on operation data representing an operation status of the vacuum pump.

10. The vacuum pump according to claim 9, wherein the controller is configured to, when a current value of a motor for driving and rotating the rotor shaft as the operation data exceeds a predetermined threshold value, determine that deposition of by-products is in progress and that the radicals need to be supplied to clean off the by-products.

11. The vacuum pump according to claim 9, wherein the controller is configured to, when a current value of a motor for driving and rotating the rotor shaft as the operation data is substantially equal to a pre-stored current value of the motor in no-load operation, control opening and closing control of the valve.

12. The vacuum pump according to claim 9, wherein the controller is configured to, when a pressure value of the vacuum pump as the operation data exceeds a predetermined threshold value, determine that deposition of by-products is in progress and that the radicals need to be supplied to clean off the by-products.

13. The vacuum pump according to claim 9, wherein the controller is configured to, when a pressure value of the vacuum pump as the operation data is substantially equal to a pre-stored pressure value of the vacuum pump in no-load operation, control opening and closing of the valve.

14. A vacuum pump cleaning system comprising:
a housing having an inlet port and an outlet port;
a rotor shaft rotationally supported inside the housing; and
a rotating body including a rotor blade fixed to the rotor shaft and is rotatable together with the rotor shaft,
the vacuum pump cleaning system further comprising:
at least one radical supply means capable of supplying a plurality of types of radicals into the housing.
